(19) United States
(12) Patent Application Publication
(10) Pub. No.: US 2006/0050063 A1
(43) Pub. Date: Mar. 9, 2006

(54) Touch panel

(76) Inventors: Koji Tanabe, Osaka (JP); Kenichi Matsumoto, Osaka (JP); Shoji Fujii, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 11/207,808

(22) Filed: Aug. 22, 2005

(30) Foreign Application Priority Data
Sep. 7, 2004 (JP) 2004-259221

(51) Int. Cl. G09G 5/00

(52) U.S. Cl. 345/173

(57) ABSTRACT

A touch panel has light-transmissive first and second substrates, a phase plate, a polarizing plate, and a correcting plate. The first substrate is formed with a first conductive layer thereon. The second substrate is provided so as to face the first substrate, and is formed with a second conductive layer thereon on the side near the first substrate, facing the first conductive layer at a given interval. The phase plate is stacked on a surface of the first substrate, opposite to a surface facing the second substrate. The polarizing plate has its heat shrinkage ratio larger than that of the phase plate, and is stacked on the side of the phase plate, opposite to the first substrate. The correcting plate has its heat shrinkage ratio equal to or smaller than that of the phase plate, and is stacked on the side of the polarizing plate, opposite to the phase plate.

### BACKGROUND OF THE INVENTION

1. Field of the Invention

The present invention relates to a touch panel used for operation of various types of electronic devices.

2. Background Art

Recent years have seen higher functionality and diversification in various types of electronic devices such as portable phones and car navigation systems. This involves an increase of devices in which their respective functions are selected with a light-transmissive touch panel attached on the front surface of its display element such as a liquid crystal panel. Consequently, touch panels with high visibility and reliable operability are demanded. A user presses a touch panel with a finger, pen, or the like, while viewing the content of the display element on the back surface of the touch panel through the touch panel, to select a function. Hereinafter, a description will be made for the conventional touch panel.

FIG. 3 is a sectional view of the conventional touch panel, in which upper conductive layer 23, light-transmissive, made of indium oxide tin or the like, is formed on the bottom surface of upper substrate 21, film-like and light-transmissive. Lower conductive layer 24, similar to upper conductive layer 23, is formed on the top surface of light-transmissive lower substrate 22. A plurality of dot spacers (not illustrated) are formed with insulating resin at given intervals on the top surface of lower conductive layer 24. A pair of upper electrodes (not illustrated) are formed at both ends of upper conductive layer 23; a pair of lower electrodes (not illustrated) are formed in a direction perpendicular to the upper electrodes at both ends of lower conductive layer 24.

Meanwhile, the outer circumferences of upper substrate 21 and lower substrate 22 are bonded each other by means of a bonding layer (not illustrated) coat-formed on the top and bottom surfaces of frame-like spacer 25, and upper conductive layer 23 faces lower conductive layer 24 at a given interval. Phase plate 26 with ¼ wavelength having form birefringence is produced by drawing a film such as polycarbonate. Polarizing plate 27 is produced by laminating triacetyl cellulose or the like on the top and bottom surfaces of polyvinyl alcohol with iodine or dye oriented. Phase plate 26 and polarizing plate 27 are stacked and bonded onto the top surface of upper substrate 21. The touch panel composed in this way is arranged on the front surface of a liquid crystal display element or the like, to be attached to an electronic device, and a pair of upper and lower electrodes are connected to the electronic circuit (not illustrated) of the device.

In the above-mentioned makeup, the user presses the top surface of polarizing plate 27 with a finger, pen, or the like, while viewing the content of the liquid crystal display element on the back surface of the touch panel. Consequently, upper substrate 21 bends along with polarizing plate 27 and phase plate 26, causing the pressed position of upper conductive layer 23 to contact with lower conductive layer 24. Then, the electronic circuit applies voltage to the upper and lower electrodes sequentially, and detects the pressed position owing to the voltage ratio between the electrodes, for selecting various functions of the device.

External light such as sunlight and lamplight from above transmits through polarizing plate 27 first. On this occasion, if polarizing plate 27 absorbs Y-directional lightwave perpendicular to X-directional lightwave, for example, the external light changes to X-directional linear polarized light, and enters phase plate 26 from polarizing plate 27. This light, as a result of transmitting through phase plate 26 with ¼ wavelength, changes from linear polarized light to circularly-polarized light, and reflects upward at lower conductive layer 24. Then, this reflected light, as a result of transmitting through phase plate 26 with ¼ wavelength again, changes to Y-directional linear polarized light with phase shift of ½ wavelength, and enters polarizing plate 27. Polarizing plate 27 allows only X-directional lightwave to transmit, and thus this Y-directional reflected light is blocked by polarizing plate 27. That is to say, the external light entered the touch panel from above reflects upward at lower conductive layer 24, however, the reflected light is blocked by polarizing plate 27 and does not exit from the top surface of polarizing plate 27 composing an operation panel. This makeup brings favorable visibility without reflection, making a liquid crystal display element or the like on the back surface easily readable. In this way, the conventional touch panel is formed by stacking and bonding phase plate 26 and polarizing plate 27 on the top surface of upper substrate 21 so that reflection of external light is eliminated and visibility is favorable. Such a touch panel is disclosed in Japanese Patent Unexamined Publication No. 2000-10732, for example.

Here, phase plate 26 made of polycarbonate has its heat shrinkage ratio of approximately 0.01% after being left for 24 hours at 85° C. Polarizing plate 27, produced by laminating triacetyl cellulose or the like onto polyvinyl alcohol, has its heat shrinkage ratio of approximately 0.5%. Such phase plate 26 and polarizing plate 27 are stacked and bonded each other. If the touch panel is used in an ambient environment with high temperature and humidity, the difference in heat shrinkage ratio causes downward warpage in the intermediate part of upper substrate 21 of the touch panel. This tends to result in unstable contact of upper conductive layer 23 and lower conductive layer 24.

### SUMMERY OF THE INVENTION

In a touch panel according to the present invention, a phase plate and polarizing plate are stacked on the top surface of the upper substrate, while a correcting plate with its heat shrinkage ratio equal to or smaller than that of the phase plate is provided on the top surface of this polarizing plate. Sandwiching the polarizing plate with its large heat shrinkage ratio by the correcting plate and the phase plate both with their small heat shrinkage ratios, prevents warpage in use under conditions with high temperature and humidity. Consequently, a touch panel with favorable visibility and reliable operability is available.

### BRIEF DESCRIPTION OF THE DRAWINGS

FIG. 1A is a top perspective view of a touch panel according to an embodiment of the present invention.

FIG. 1B is a sectional view of the touch panel shown in FIG. 1A.

FIG. 2 is a sectional view of another touch panel according to the embodiment of the present invention.

FIG. 3 is a sectional view of a conventional touch panel.

### DETAILED DESCRIPTION OF THE INVENTION

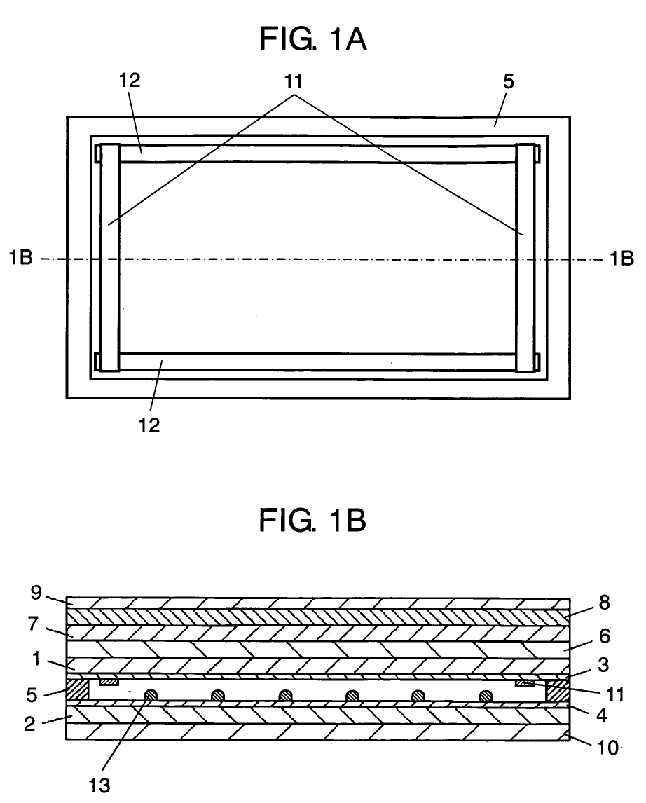

FIG. 1A is a top perspective view of a touch panel according to an embodiment of the present invention. FIG. 1B is a sectional view of the touch panel shown in FIG. 1A, taken along line 1B-1B. Here, the figure shows its dimensions enlarged in the thickness direction in order to help the makeup to be easily understood.

Upper substrate (hereinafter, substrate) 1, which is a film-like light-transmissive first substrate, is made of polyethersulfone, polycarbonate, or the like. Lower substrate (hereinafter, substrate) 2, which is a light-transmissive second substrate provided so as to face substrate 1, is made of glass, acrylic resin, polycarbonate, or the like. Upper conductive layer (hereinafter, conductive layer) 3, which is a light-transmissive first conductive layer made of indium-tin oxide, tin oxide, or the like, is formed with sputtering or the like, on the bottom surface of substrate 1, namely at the side facing substrate 2. Lower conductive layer (hereinafter, conductive layer) 4, similar to conductive layer 3, is formed on the top surface of substrate 2, namely at the side facing substrate 1. Dot spacers 13 are formed with insulating resin such as epoxy or silicon, at given intervals on the top surface of conductive layer 4. A pair of upper electrodes 11, made of silver, carbon, or the like, are formed at both ends of conductive layer 3; a pair of lower electrodes 12, perpendicular to upper electrodes 11, are formed at both ends of conductive layer 4.

Frame-like spacer 5 is made of nonwoven fabric, polyester film, or the like. The outer circumferences of substrate 1 and substrate 2 are bonded by means of a bonding layer (not illustrated) coat-formed on the top and bottom surfaces of spacer 5, and conductive layers 3 and 4 face each other at a given interval.

Upper phase plate (hereinafter, phase plate) 6, which is a first phase plate with ¼ wavelength having form birefringence, is produced by drawing a film such as polycarbonate. Polarizing plate 7 is produced by laminating triacetyl cellulose or the like on the top and bottom surfaces of polyvinyl alcohol with iodine or dye oriented. Phase plate 6 is stacked on the top surface of substrate 1; polarizing plate 7 is stacked on the top surface of phase plate 6. In other words, phase plate 6 is stacked on the surface of substrate 1, opposite to that facing substrate 2; polarizing plate 7 is stacked on the side of phase plate 6, opposite to substrate 1. These plates are bonded by means of an adhesive (not illustrated) such as acrylic.

Correcting plate 8, film-like and light-transmissive, is made of polycarbonate or the like. Correcting plate 8 is stacked and bonded onto the top surface of polarizing plate 7. In other words, correcting plate 8 is stacked on the side of polarizing plate 7, opposite to phase plate 6. Further, light-transmissive hard-coating layer 9, made of photo-setting acrylic resin or the like, is provided on the top surface of correcting plate 8.

Polarizing plate 7, produced by laminating triacetyl cellulose or the like on polyvinyl alcohol, has its heat shrinkage ratio of approximately 0.5% after being left for 24 hours at 85° C. Both correcting plate 8 and phase plate 6 are formed with polycarbonate or the like with its heat shrinkage ratio of approximately 0.01%. In this way, the heat shrinkage ratio of polarizing plate 7 is larger than those of phase plate 6 and correcting plate 8. That is to say, phase plate 6 and correcting plate 8 with its heat shrinkage ratio roughly equal to or smaller than that of phase plate 6, sandwich polarizing plate 7 with its large ratio. Correcting plate 8 may be made of other material as long as its heat shrinkage ratio is equal to or smaller than that of phase plate 6.

Lower phase plate (hereinafter, phase plate) 10, which is a second phase plate similar to phase plate 6, is bonded onto the bottom surface of substrate 2, so as to compose a touch panel. The touch panel composed in this way is arranged on the front surface of a liquid crystal display element or the like, to be attached to an electronic device, and pairs of upper and lower electrodes 11 and 12 are respectively connected to the electronic circuit (not illustrated) of the device.

In the above-mentioned makeup, a user presses the top surface of hard-coating layer 9 with a finger, pen, or the like, while viewing the content of the liquid crystal display element on the back surface of the touch panel. Consequently, substrate 1 bends along with correcting plate 8, polarizing plate 7, and phase plate 6, causing the pressed position of conductive layer 3 to contact conductive layer 4. Then, the electronic circuit applies voltage to upper electrodes 11 and lower electrodes 12 sequentially, and detects the pressed position owing to the voltage ratio between the electrodes, for selecting various functions of the device.

External light such as sunlight and lamplight from above, after passing through hard-coating layer 9 and correcting plate 8, first transmits through polarizing plate 7. On this occasion, if polarizing plate 7 absorbs Y-directional lightwave perpendicular to X-directional lightwave, for example, the external light changes to X-directional linear polarized light, and enters phase plate 6 from polarizing plate 7.

Next, this light, as a result of transmitting through phase plate 6 with ¼ wavelength, changes from linear polarized light to circularly-polarized light, and reflects upward at conductive layer 4. Then, this reflected light, as a result of transmitting through phase plate 6 with ¼ wavelength again, changes to Y-directional linear polarized light with phase shift of ½ wavelength out, and enters polarizing plate 7. Polarizing plate 7 allows only X-directional lightwave to transmit, and thus this reflected light, which is Y-directional linear polarized light, is blocked by polarizing plate 7. That is to say, the external light entered the touch panel from above reflects upward at lower conductive layer 4, however, the reflected light is blocked by polarizing plate 7 and does not exit from hard-coating layer 9 composing an operation panel, or the top surfaces of correcting plate 8. This makeup brings favorable visibility of a liquid crystal display element or the like on the back surface, without reflection.

Meanwhile, lamplight from the liquid crystal display element or the like on the back surface of the touch panel could be Y-directional linear polarized light. The lamplight passes through phase plate 10 with ¼ wavelength first, and then phase plate 6 with the same wavelength. This causes the lamplight, which has been Y-directional linear polarized light, changes to X-directional linear polarized light with phase shift of ½ wavelength, and enters polarizing plate 7. The lamplight further transmits through polarizing plate 7 and correcting plate 8, and exits from the top surface of hard-coating layer 9 composing the operation panel. That is to say, the lamplight changes to X-directional linear polarized light by transmitting through phase plates 10 and 6, and exits from the top surface of hard-coating layer 9 with phase shift of ½ wavelength. Consequently, the user can clearly view the content of the liquid crystal display element or the like on the back surface of the touch panel.

Correcting plate 8 is desirably composed of a phase plate similar to phase plates 6 and 10. In such a makeup, the lamplight from the liquid crystal display element or the like, that has changed to linear polarized light through polarizing plate 7, changes to circularly-polarized light owing to correcting plate 8. Consequently, a user wearing polarized sunglasses or the like for X-directional linear polarization, for example, can easily view the lamplight.

Meanwhile, correcting plate 8 and phase plate 6 with their heat shrinkage ratios roughly equal and small, sandwich polarizing plate 7 with its large heat shrinkage ratio. Consequently, even if used in an ambient environment with high temperature and humidity, correcting plate 8 and phase plate 6 suppress warpage of polarizing plate 7 with its large heat shrinkage ratio. This prevents warpage of the entire makeup, implementing a touch panel with favorable visibility and reliable operability.

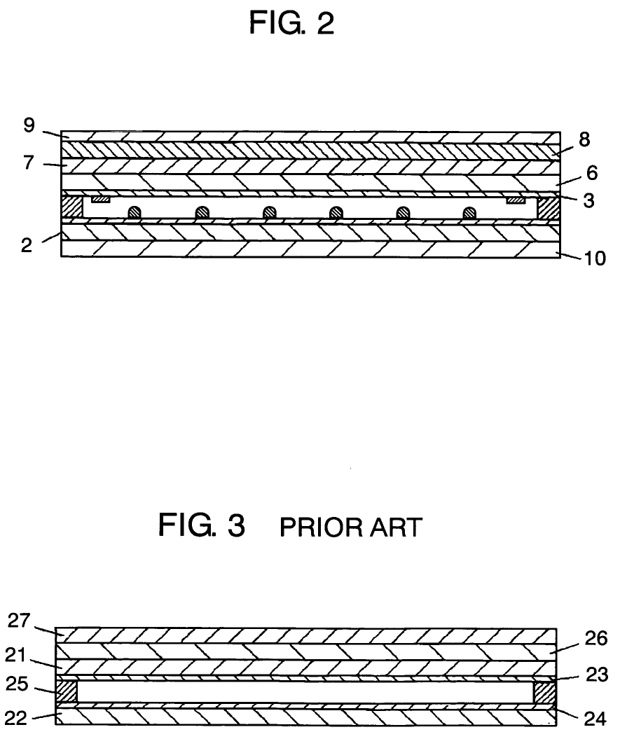

Alternatively, conductive layer 3 may be formed directly on the bottom surface of phase plate 6, instead of substrate 1, as shown in the sectional view of FIG. 2. In other words, phase plate 6, doubling as substrate 1, may form conductive layer 3 on the side near substrate 2. This makeup dispenses with substrate 1 and decreases the number of required components, allowing a touch panel to be formed at a low cost.

In the above-mentioned description, phase plate 6 and correcting plate 8 are to be made of polycarbonate or the like with its heat shrinkage ratio as small as approximately 0.01% after being left for 24 hours at 85° C. Besides such materials, other material with its small heat shrinkage ratio such as polyethylene terephthalate and cycloolefin polymer that have undergone heat annealing treatment can be used for phase plate 6 and correcting plate 8. Using such materials brings the same effect. These materials may be blended. This makeup is effective if material composing phase plate 6 and correcting plate 8 has its heat shrinkage ratio after being left for 24 hours at 85° C., roughly not larger than that of polarizing plate 7.

As mentioned above, a touch panel according to the present invention has favorable visibility and reliable operability, thus useful for operating various types of electronic devices.

What is claimed is:

1. A touch panel comprising:
a first substrate being light-transmissive and formed with a first conductive layer;
a second substrate being light-transmissive, provided so as to face the first substrate, and formed with a second conductive layer facing the first conductive layer at a given interval, on a side of the first substrate;
a phase plate stacked on a surface of the first substrate, opposite to a surface facing the second substrate;
a polarizing plate stacked on a side of the phase plate, opposite to the first substrate, and having a heat shrinkage ratio larger than that of the polarizing plate; and
a correcting plate stacked on a side of the polarizing plate, opposite to the phase plate, and has a heat shrinkage ratio not larger than that of the phase plate.

2. The touch panel according to claim 1, wherein the phase plate and the correcting plate include at least one of polycarbonate, polyethylene terephthalate, and cycloolefin polymer.

3. The touch panel according to claim 1, wherein the phase plate doubles as the first substrate, and the first conductive layer is formed on a surface of the phase plate, on a side near the second substrate.

4. The touch panel according to claim 1, wherein the correcting plate is made of a phase plate.
